(19) United States
(12) Patent Application Publication
(10) Pub. No.: US 2021/0304633 A1
(43) Pub. Date: Sep. 30, 2021

(54) NOTEBOOK FOR EDUCATIONALLY CHALLENGED STUDENTS

(71) Applicant: I PROJECT EDUCATIONAL EMPOWERMENT LTD, Ashdod (IL)

(72) Inventor: David Botrashvili (Boterson), Ashdod (IL)

(21) Appl. No.: 17/257,352

(22) PCT Filed: Aug. 20, 2018
(86) PCT No.: PCT/IB2018/056275

§ 371 Date: Dec. 31, 2020

Related U.S. Application Data
(60) Provisional application No. 62/547,273, filed on Aug. 18, 2017.

(51) Int. Cl. G09B 11/04

(52) U.S. Cl. CPC G09B 11/04

(57) ABSTRACT

A notebook configured to enhance cognitive focus, comprising a plurality of sheets, each sheet having a series of parallel writing rows of a first color separated by parallel spacing rows of a second color, wherein the first color is obtained by printing at a setting that is from 5% to 10% of the first color using printing software, wherein the second color is obtained by printing at a setting that is from 10% to 15% of the second color using printing software, wherein the percentage used in the printing setting for the second color is greater than the percentage used in the printing setting for the first color by five or more percentage points, wherein lines bordering the writing rows and the spacing rows are in the second color and are obtained by printing at a setting that is from 18% to 22% of the second color using printing software.

### FIELD AND BACKGROUND OF THE INVENTION

The invention relates to products, for example notebooks, for educationally challenged students.

There are many types of students who are disturbed by the visual appearance of learning materials such as school notebooks. These include students with learning disorders, students with visual stress, visually impaired students (including impaired sharpness of vision, limited field of vision, students with difficulty focusing on a desired point, impaired perception and difficulty deciphering images), students with visual processing disorders and ordinary students who react negatively to the visual layout and content of the notebooks and other instructions materials.

One reason this is important even for students without learning disabilities is that scientists have discovered that writing by hand is important for cognitive development, as compared to recording data by typing using a data input device. According to an article in the NY Times in 2016, writing by hand is immeasurably important for the cognitive development of children and students, in contrast with digital writing, according to pediatric specialist Perri Klass, MD in the research survey she collected and summarized in the article. The article goes on to say that handwriting is not a motor skill, but rather a cognitive skill. Schoolchildren and college students who write by hand stimulate cognitive regions in the brain that develop planning and thinking skills, and the result is better language development.

An earlier NY Times article in 2014 asserts that studies found that handwriting, as opposed to keyboard input, actually sharpens the memory significantly. For example, students who took notes by hand had better test results than their peers who typed their notes on the computer. The act of writing gave them an advantage in retaining the information and thinking of new, creative ideas. Psychologists explain that this is because writing takes more attention and thought than typing on a computer. Children who learn writing skills first learn to read faster, and gain an advantage in terms of their ability to create ideas and retain information. “When we write, a unique neural circuit is automatically stimulated,” says Prof. Stanislas Dehaene, a cognitive neuroscientist at the College de France in Paris. “It seems that the circuit plays a role that we were previously unaware of and the learning process becomes easier,” he adds. In contrast to use of a keyboard, according to Professor Stanislas Dehaene, it is only when a person writes that a neural circuit locks in the brain, and this action dramatically improves memory, creativity and linguistic competence.

### SUMMARY OF THE INVENTION

One aspect of the invention is an instructional writing paper notebook configured to enhance cognitive focus, comprising a plurality of sheets, each sheet having a series of parallel writing rows of a first color separated by parallel spacing rows of a second color, wherein a background of the sheet is of the first color, wherein the first color is obtained by printing at a setting that is from 5% to 10% of the first color using either digital printing software or offset printing software, wherein the second color is obtained by printing at a setting that is from 10% to 15% of the second color using either digital printing software or offset printing software, wherein the percentage used in the printing setting for the second color is greater than the percentage used in the printing setting for the first color by five or more percentage points, wherein lines bordering the writing rows and the spacing rows are in the second color, and the lines are obtained by printing at a setting that is from 18% to 22% of the second color using either digital printing software or offset printing software.

In some embodiments, the first color is yellow or beige and the second color is cyan or blue. In some embodiments, the first color and the second color are the same color s and are chosen from blue, green, peach, pink and gray. In some embodiments, the first color is beige or cream or cosmic latte and the second color is cyan or blue.

In some embodiments, the sheets are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein an instructional statement is written on the pages of the notebook to prompt such gluing.

In some embodiments, model letters and/or model numbers appear on at least some of the pages, the model letters and/or model numbers including arrows instructing how to form the model letters and/or model numbers. In some embodiments, the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

In some embodiments, no part of the sheets is white and no part of the sheet has a bright color.

Another aspect of the invention is an instructional writing paper notebook configured to enhance cognitive focus, comprising a plurality of sheets, wherein for each sheet: a series of parallel writing rows of a first color is separated by parallel spacing rows of a second color; a background of the sheet is of the first color; the first color is beige or a variation of beige and has color coordinates within the following ranges of an RGB system normalized to [0 to 255] bytes: R=[240 to 255], G=[240 to 255], B=[207 to 232]; the second color is one of light blue, light sky blue, alice blue; lines bordering the writing rows and the spacing rows are in the second color and the lines are a shade of the second color that is darker than a shade of the second color appearing in the parallel spacing rows.

In some embodiments, the sheets are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein an instructional statement is written on the pages of the notebook to prompt such gluing.

In some embodiments, model letters and/or model numbers appear on at least some of the pages, the model letters and/or model numbers including arrows instructing how to form the model letters and/or model numbers. In some embodiments, the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

In some embodiments, the first color has color coordinates within the following ranges of an RGB system normalized to [0 to 255] bytes: R=[254 to 255], G=[248 to 253], B=[207 to 232].

In some embodiments, the first color has color coordinates within the following ranges of an RGB system normalized to [0 to 255] bytes: R=[254 to 255]. G=[247 to 249]. B=[230 to 232].

In some embodiments, the first color has color coordinates within the following ranges of an RGB system normalized to [0 to 255] bytes: R=[254 to 255], G=[252 to 254], B=[207 to 209].

In some embodiments, the second color is light blue wherein at least one of the following is true: (A) the light blue has color coordinates within the following ranges of an RGB system normalized to [0 to 255] bytes: R=[235 to 245]. G=[243 to 253]. B=[255] (B) the light blue has color coordinates within the following ranges of an RGB system normalized to [0 to 255] bytes: R=[168 to 178]. G=[211 to 221]. B=[225 to 235] and (C) the light blue has color coordinates within the following ranges of an RGB system normalized to [0 to 255] bytes: R=[130 to 140], G=[201 to 211], B=[245 to 255].

A further aspect of the invention is an instructional writing paper notebook configured to enhance cognitive focus, comprising a plurality of sheets, wherein for each sheet: a series of parallel writing rows of a first color is separated by parallel spacing rows of a second color; a background of the sheet is of the first color; the first color is beige, a variation of beige or light yellow, the variation of beige being cosmic latte or cream; the second color is a light blue or a light sky blue or is alice blue; lines bordering the writing rows and the spacing rows are in the second color and the lines are a shade of the second color that is darker than a shade of the second color appearing in the parallel spacing rows.

In some embodiments, the sheets are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein an instructional statement is written on the pages of the notebook to prompt such gluing.

In some embodiments, model letters and/or model numbers appear on at least some of the pages, the model letters and/or model numbers including arrows instructing how to form the model letters and/or model numbers. In some embodiments, the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

A still further aspect of the invention is an instructional writing paper notebook configured to enhance cognitive focus, comprising a plurality of sheets, wherein for each sheet: a series of parallel writing rows of a first color is separated by parallel spacing rows of a second color; a background of the sheet is of the first color; the first color has color coordinates within the following ranges of an RGB system normalized to [0 to 255] bytes: R=[240 to 255], G=[220 to 255], B=[200 to 232]; the second color has color coordinates within the following ranges of an RGB system normalized to [0 to 255] bytes: R=[240 to 255]. G=[220 to 255]. B=[200 to 232]; lines bordering the writing rows and the spacing rows are in the second color and the lines are a shade of the second color that is darker than a shade of the second color appearing in the parallel spacing rows.

A yet still further aspect of the invention is an instructional writing paper notebook configured to enhance cognitive focus, comprising a plurality of sheets, wherein for each sheet: a series of parallel writing rows of a first pastel color is separated by parallel spacing rows of a second pastel color; a background of the sheet being of the first pastel color; lines bordering the writing rows and the spacing rows are in the second pastel color and the lines are a first shade of the second pastel color that is darker than a second shade of the second pastel color appearing in the parallel spacing rows; the sheets have no pure white on them and have no bright colors on them.

In some embodiments, at least one of the first pastel color and the second pastel color are a shade of one of the following pastel colors: yellow, blue, green, peach, pink, beige, gray.

In some embodiments, model letters and/or model numbers appear on at least some of the pages, the model letters and/or model numbers including arrows instructing how to form the model letters and/or model numbers. In some embodiments, the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

Certain embodiments of the invention seek to provide a notebook or page or set of pages developed on the basis of extensive teaching experience and having all or any subset of the following characteristics:
1. notebook page allows visual focus on the writing row, and cognitive focus during writing and learning processes.
2. Writing row color is light yellow, and line spacing color is light blue. These 2 colors, by way of example, or alternatively other low contrast colors e.g. writing row may be light green and spacing may be gray, or vice versa, induce a high level of relaxation in the learning disability community which is disturbed by contrast with white color regions e.g. background, due to the high reflectivity of white.
3. Writing rows are not marked with strong lines due to the contrast, which bothers these students, and instead may comprise writing row and marked spacing line of a blue color. The user e.g. child clearly distinguishes between writing row and spacing line.
4. Notebook page is few mm bigger then A4 size, which allows working papers given to students, to be placed smoothly at the edge of the page and become part of the notebook
5. Notebook fastened by staples or pins
6. At the edge of each page of the notebook there's special instruction of how and where to glue the working paper, so that the glued page will be browsed as part of the notebook
7. There are letters and/or numbers bar in each model e.g. each page, which includes writing instruction arrows, all to enable writing skills and design an easy and precise letters.

According to certain embodiments, the writing and spacing rows can each be any suitable color known to be calming and/or low contrast.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various embodiments are herein described, by way of example only, with reference to the accompanying drawings, wherein:

FIG. 1 is a front view of a sheet with the first color in beige and the second color in light blue, in accordance with an embodiment of the invention;

FIGS. 2A-1 and FIG. 2A-2 are color front views of two adjacent sheets with the first and second colors in different hues of blue, in accordance with an embodiment of the invention;

FIGS. 2B-1 and FIG. 2B-2 are color front views of two adjacent sheets with the first and second colors in different hues of grey, in accordance with an embodiment of the invention;

FIGS. 2C-1 and FIG. 2C-2 are color front views of two adjacent sheets with the first and second colors in different hues of pink, in accordance with an embodiment of the invention;

FIGS. 2D-1 and FIG. 2D-2 are color front views of two adjacent sheets with the first and second colors in different hues of peach, in accordance with an embodiment of the invention:

FIG. 3 is a front view of a sheet, in accordance with an embodiment of the invention;

FIG. 4 is a front view of a sheet, in accordance with an embodiment of the invention;

FIG. 5 is a front view of a sheet, in accordance with an embodiment of the invention;

FIG. 6 is a schematic plan view of an opened notebook, in accordance with an embodiment of the invention;

FIG. 7A is a photograph in which a part of a notebook has pages attached to one or more sheets of the notebook, in accordance with one embodiment of the invention;

FIG. 7B is a photograph in which a part of a notebook has pages attached to one or more sheets of the notebook, in accordance with one embodiment of the invention;

FIG. 7C is a photograph in which a part of a notebook has pages attached to one or more sheets of the notebook, in accordance with one embodiment of the invention; and

FIG. 8 is a photograph of a sheet of a notebook wherein the first color is beige and the second color is a blue hue.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Our children's learning challenges are dramatically different than the challenges faced by students in the past. Therefore, it is necessary to develop tools that will enable students to write with greater ease and not strain their brains unnecessarily. In CT scans of a child with an attention deficit disorder, it is easy to see how much effort is put into such a simple task as “focusing on the line for writing.” It is important to understand that over 50% of children in the information age have difficulty focusing on the line for writing, and it is even harder for them to understand where they are supposed to write—something that seems clear to any average parent. Regular notebooks have various different lines and there is no clear distinction between the lines for spacing and the lines for writing, which makes things very hard for the beginning student trying to understand where to write. In the keyboard age, distractions are everywhere, and every small thing in the student's workspace is liable to catch his attention easily.

Among students with attention deficit disorders, the situation is even worse, because the background of the notebook and many lines prevent them from effectively focusing on the line for writing. Since their brain is busy deciphering the lines, these students have a very hard time writing in their notebooks or summarizing the teacher's explanations.

Applicant has experimented with well over 50.000 students to determine how to reduce visual stress and improve cognitive focus. Following 17 years of studies and research with ordinary students, individuals with learning difficulties, learning disorders (ADD/ADHD), impaired vision, and visually processing disorders, Applicant found that use of certain embodiments of the notebook of the invention improves learning and writing skills for these students.

The notebook of the invention was developed and designed to enable all types of students a maximal level of focus and ease in writing. Applicant has determined that one of the biggest challenges that students face at the beginning of their handwriting development is difficulty becoming oriented with the line for writing.

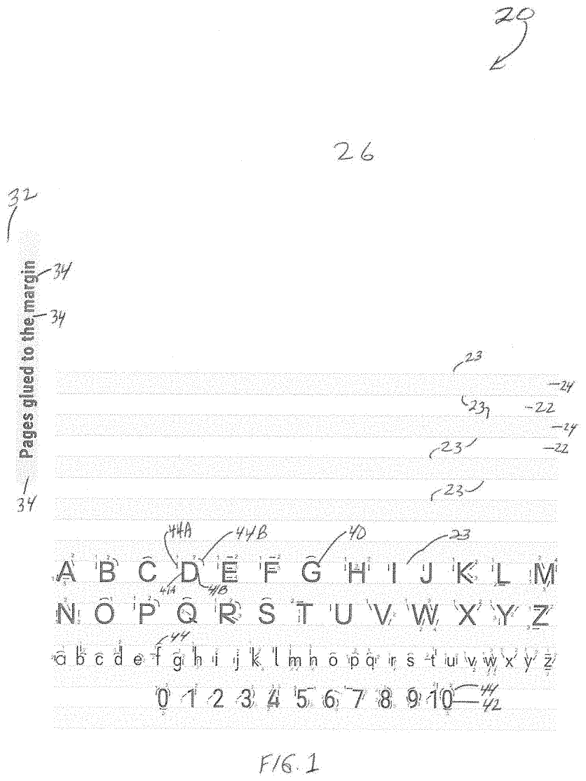

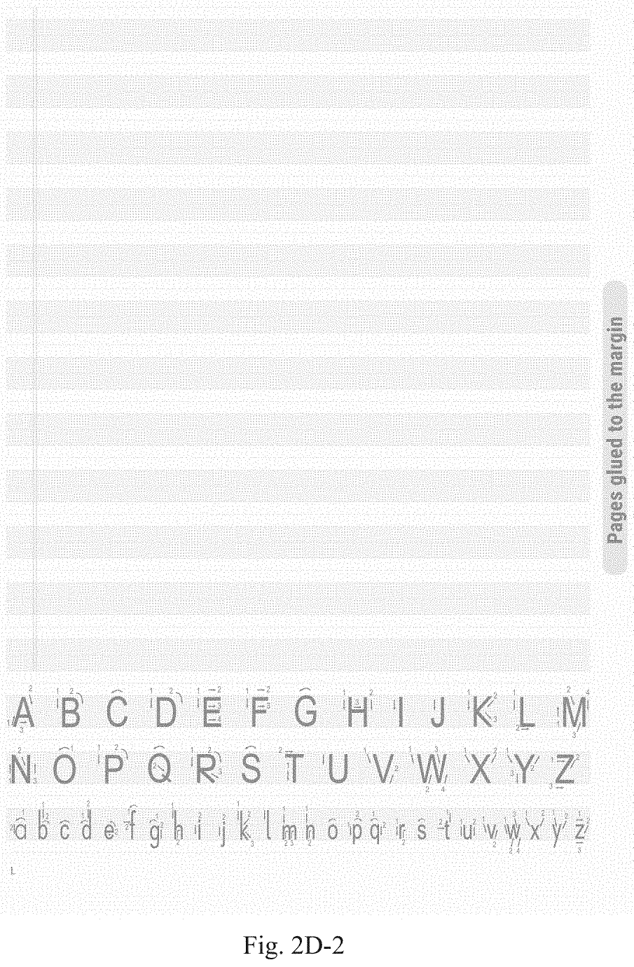

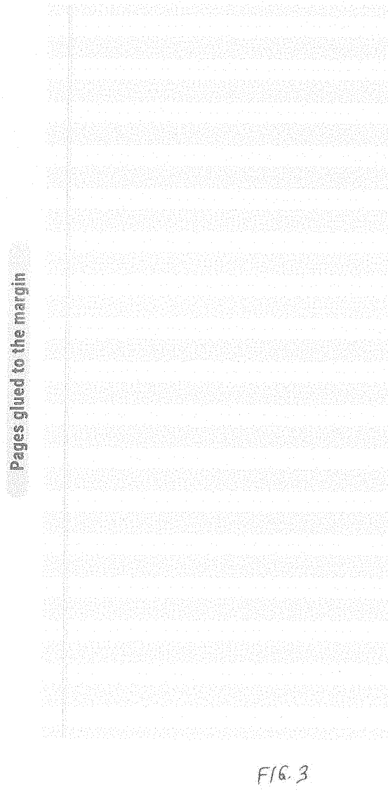

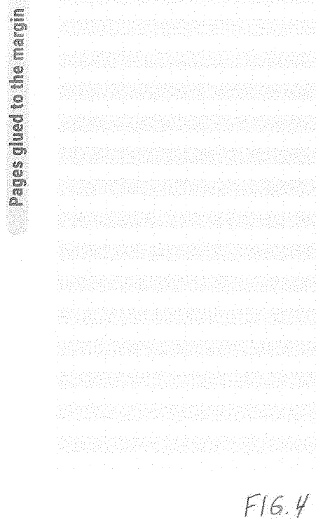

The invention generally provides a notebook for students that minimizes visual stress and optimizes cognitive focus. Students who can benefit from this include students with learning disorders or visual stress, visually impaired students (including impaired sharpness of vision, limited field of vision, difficulty focusing on a desired point, impaired perception and difficulty deciphering images), students with visual processing disorders and ordinary students who react negatively to the visual layout and content of the notebooks and other instructions materials. The notebook in some embodiments has no bright white or other bright colors or strong color contrasts. Instead, the notebook has in some embodiments a plurality of sheets, each sheet having parallel writing rows of a first color separated by parallel spacing rows of a second color. The rows may be coextensive, as in FIGS. 1-5.

The first color is non-bright color in some embodiments, such as a yellow. In some embodiments, the yellow color is obtained by printing at a setting that is anywhere from 5% yellow to 10% yellow using either digital printing software or offset printing software. Examples of digital printing software are Adobe Systems' InDesign or Photoshop® software products. Although there can be some slight variation in color in the printed outcome amongst difference printers with the same color setting or by printing using the same printer on different days, these differences are very slight and the invention is intended to encompass notebooks printed even with such slight differences, at least in most embodiments.

In some embodiments, the first color (for the writing rows) and the second color (for the spacing rows) are not white and the sheet does not contain any areas of white or any bright color. In some embodiments, the first color is beige or a variation of beige, for example cosmic latte or cream. The second color is a light blue. Cosmic latte is described by astronomers as the average color of the universe.

In some embodiments, the first color is obtained by printing at a setting of the first color of somewhere between 5% and 10% and the second color is obtained by printing at a setting that is from 10% cyan to 15% of the second color using either digital printing software or offset printing software. The printing setting for the second color is typically at least five percentage points higher than the printing setting for the first color so that there is a visual contrast. On each page, there are lines bordering the writing rows and the spacing rows and these lines are in the second color. In some embodiments, these lines are obtained by printing at a setting that is from 18% to 22% of the second color using either digital printing software or offset printing software. In some embodiments, these lines are light blue but somewhat darker than the light blue of the second color.

The principles and operation of a notebook for educationally challenged students may be better understood with reference to the drawings and the accompanying description.

As can be seen from FIGS. 1-6, an instructional writing paper notebook 10 is configured to enhance cognitive focus. Notebook 10 comprises a plurality of sheets 20. In one embodiment, each sheet has a series of parallel writing rows 22 of a first color separated by parallel spacing rows 24 of a second color. The color of the background 26 of the sheet 20 is of the first color.

In some embodiments, the first color is obtained by printing at a setting that is from 5% yellow to 10% yellow using either digital printing software or offset printing software.

In some embodiments, the second color is obtained by printing at a setting that is from 10% to 15% of the second color using either digital printing software or offset printing software, where the percentage used in the printing setting for the second color is greater than the percentage used in the printing setting for the first color by five or more percentage points. For example, if the first color is set for printing at yellow 7% the second color is set for printing at cyan 12% or cyan 13% or cyan 14% or cyan 15%.

Typically, the lines 23 bordering the writing rows 22 and the spacing rows 24 are in the second color. Lines 23 are darker than the shade of the second color used for the spacing rows 24. For example, in some embodiments, the border lines 23 are obtained by printing at a setting that is from 18% to 22% of the second color using either digital printing software or offset printing software.

In some embodiments, the sheets 20 have no bright color or plain white on them.

The colors used as the first color and as the second color are, in some embodiments, any non-bright color that is a pale shade that does not create a strong contrast. Examples are various shades of yellow, blue, green, cyan, peach, pink or gray (or another color) that are pale. This is achieved by setting the printing of the first color (for the writing rows 22) at anywhere from 5% and 10% and by setting the printing of the second color (for the spacing rows 24) at anywhere from 10% to 15% for the spacing row, provided the setting for the second color (spacing row 24) is at least 5 percentage points higher than the setting for the first color (writing row 22) so there is enough visual contrast to see the rows 22, 24. In one non-limiting example, the setting for the first color used for the writing row 22 is set at 7% of the first color and the setting for the second color for the spacing row 24 is set at 12% of the second color (or in some embodiments at 13% or at 14% or at 15%).

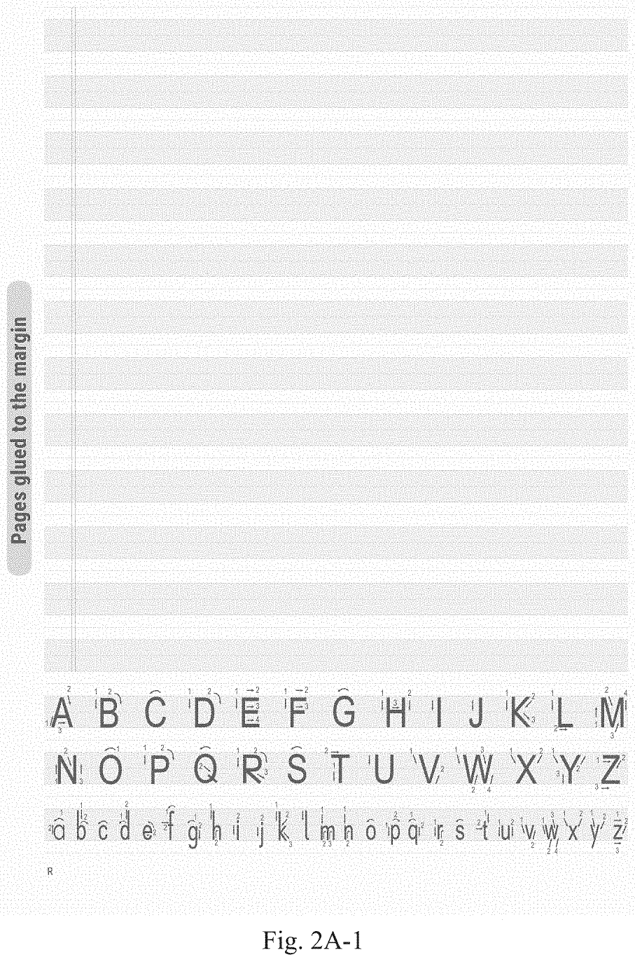

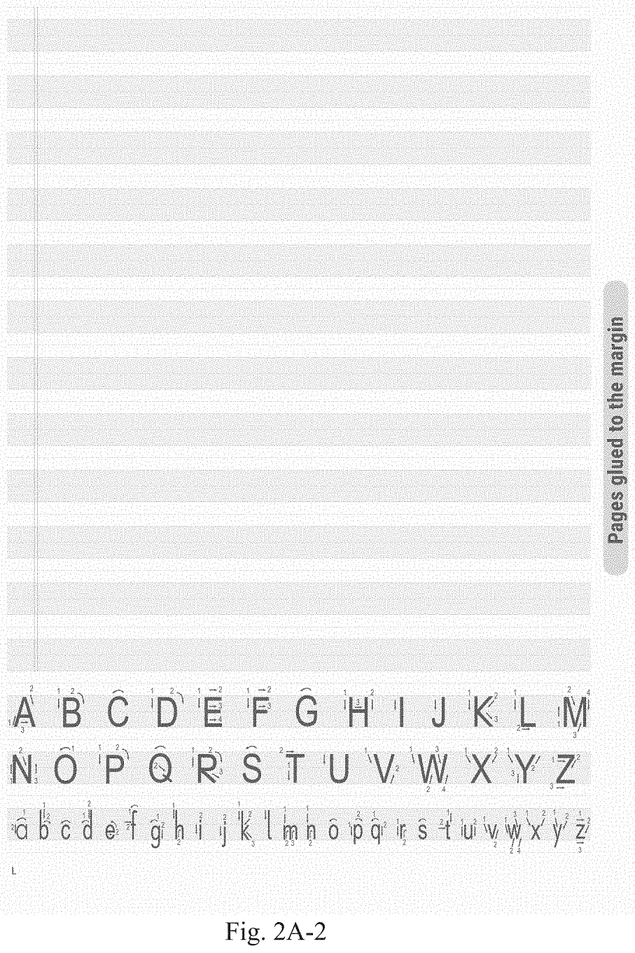

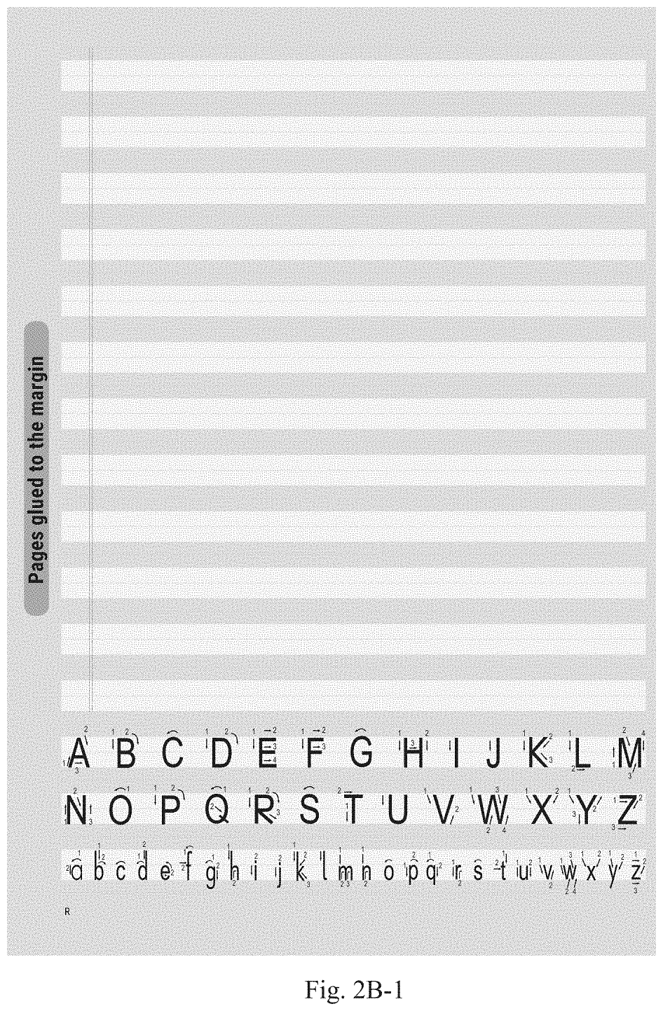

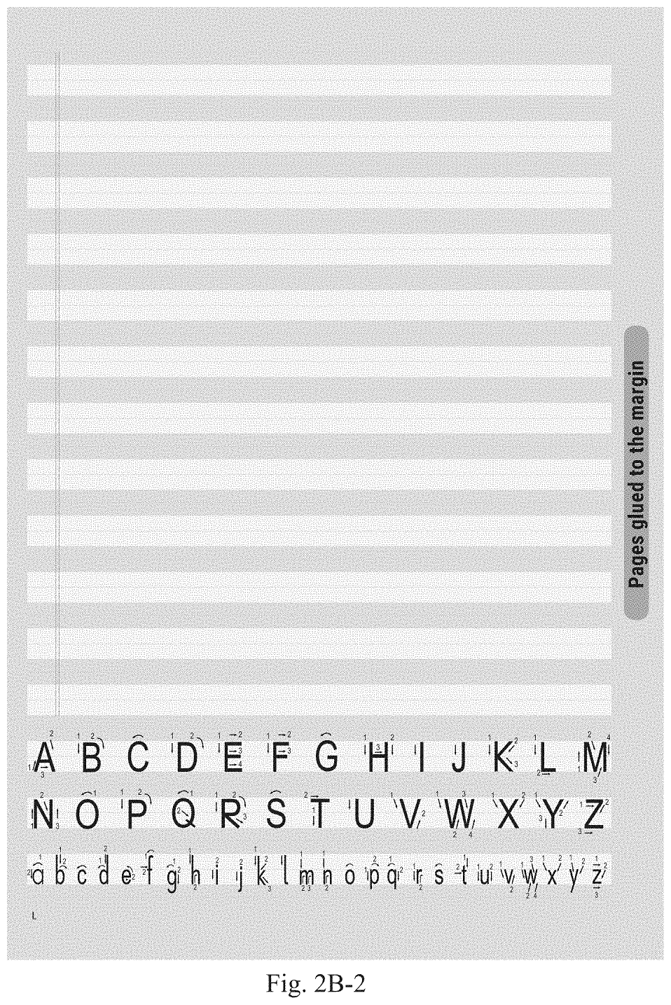

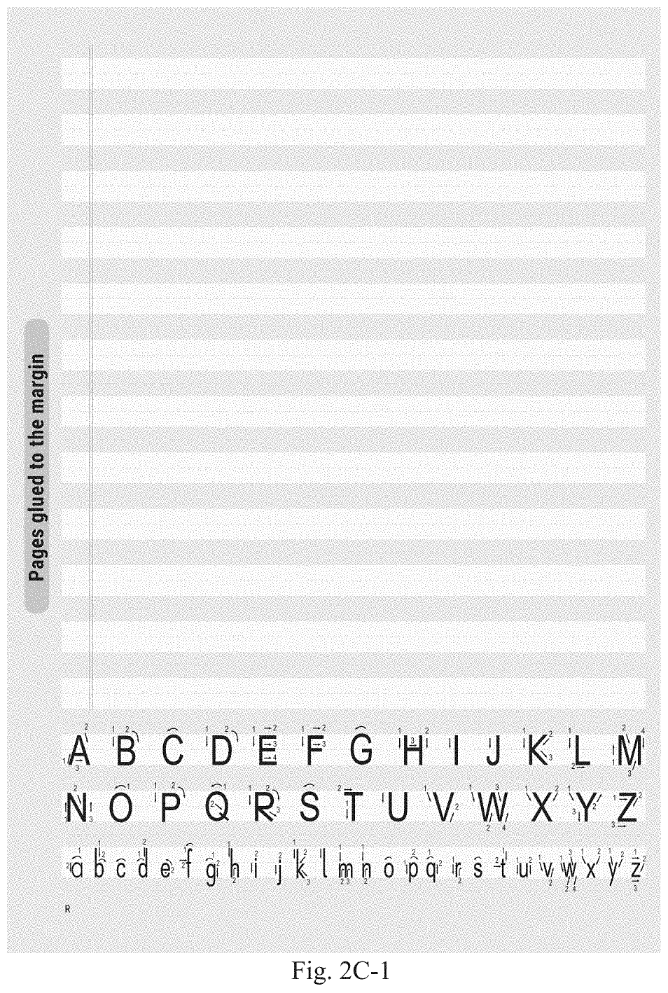

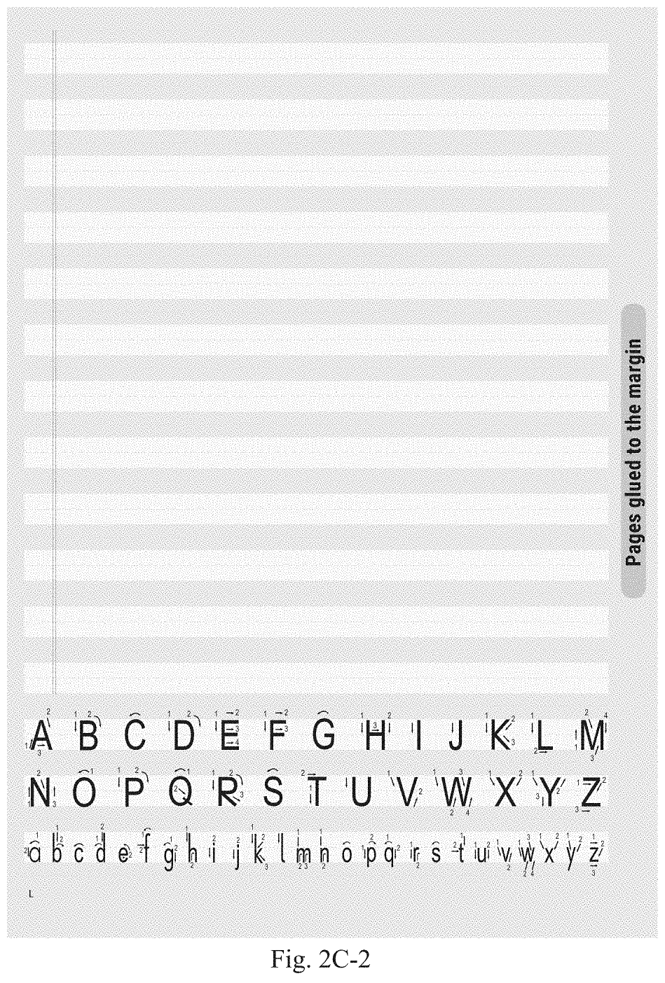

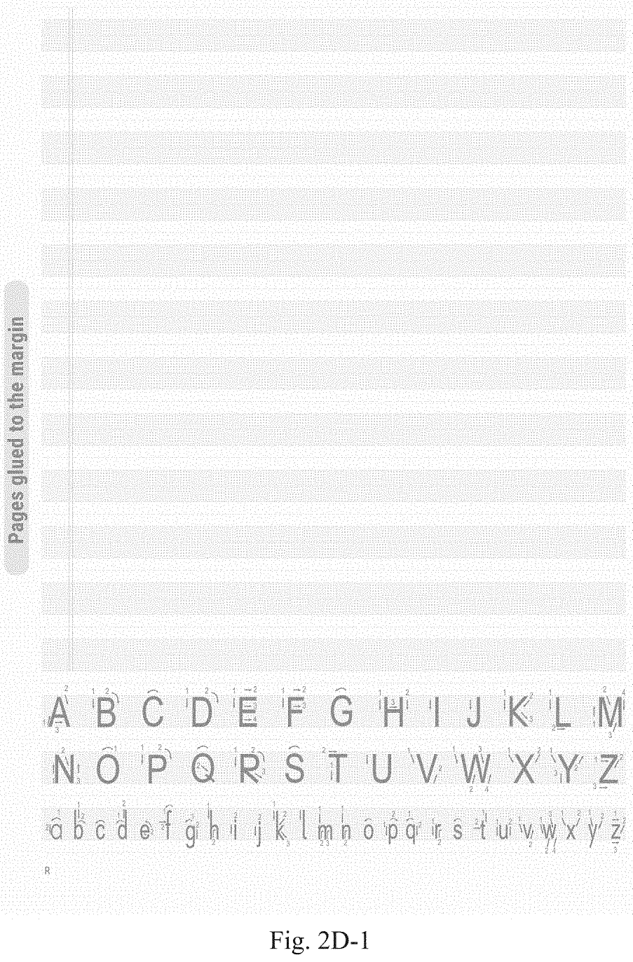

In some embodiments, both the first and second colors are the same basic color and the difference between the first and second colors is in the hue, which in some embodiments is determined by the printing setting (for example 5% to 10% for the first color and 10% to 15% for the second color with the setting for the printing of the second color setting being at least five percentage points more than the setting for the printing for the first color). Non-limiting examples of this arrangement are provided in FIG. 2A-1 and FIG. 2A-2 (blue), FIG. 2B-1 and FIG. 2B-2 (gray), FIG. 2C-1 and FIG. 2C-2 (pink) and FIG. 2D-1 and FIG. 2D-2 (peach). In each of these figures the first color is lighter hue of the second color. For example, the first color is a light hue of blue in FIGS. 2A-1 and 2A-2, a light hue of gray in FIGS. 2B-1 and 2B-2, a light hue of pink in FIGS. 2C-1 and 2C-2 and a light hue of peach in FIGS. 2D-1 and 2D-2, and in each of these examples the second color is a darker hue of such colors respectively. These are merely non-limiting examples. The border line 23 between the writing rows 22 and the spacing rows 24 (which is between the first color and the second color) is, in some embodiments, set at a printing setting of about 20% of the second color (18-22%) using offset printing software or digital printing software.

In another embodiment, the first color is a light yellow or beige. In some embodiments, the first color is beige or a variation of beige or a light yellow, wherein the variations of beige are or include cosmic latte and cream.

The invention, in one general embodiment, is an instructional writing paper notebook 10 configured to enhance cognitive focus, comprising a plurality of sheets 20, wherein for each sheet 20: a series of parallel writing rows 22 of a first pastel color is separated by parallel spacing rows 24 of a second pastel color; a background of the sheet 20 being of the first pastel color. The lines 23 bordering the writing rows 22 and the spacing rows 24 are in the second pastel color and these lines are a first shade of the second pastel color that is darker than a second shade of the second pastel color appearing in the parallel spacing rows 24. Typically, the sheets 20 have no pure white on them and have no bright colors on them. In one non-limiting embodiment, the first pastel color and the second pastel color are each shades of one of the following pastel colors: yellow, blue, green, peach, pink, beige, gray. In another non-limiting embodiment, at least one of the first pastel color and the second pastel color are shades of one of the following pastel colors: yellow, blue, green, peach, pink, beige, gray. In this general embodiment, any suitable details discussed with respect to other embodiments may apply (model letters and/or numbers, arrows, attachment of working sheets, etc.).

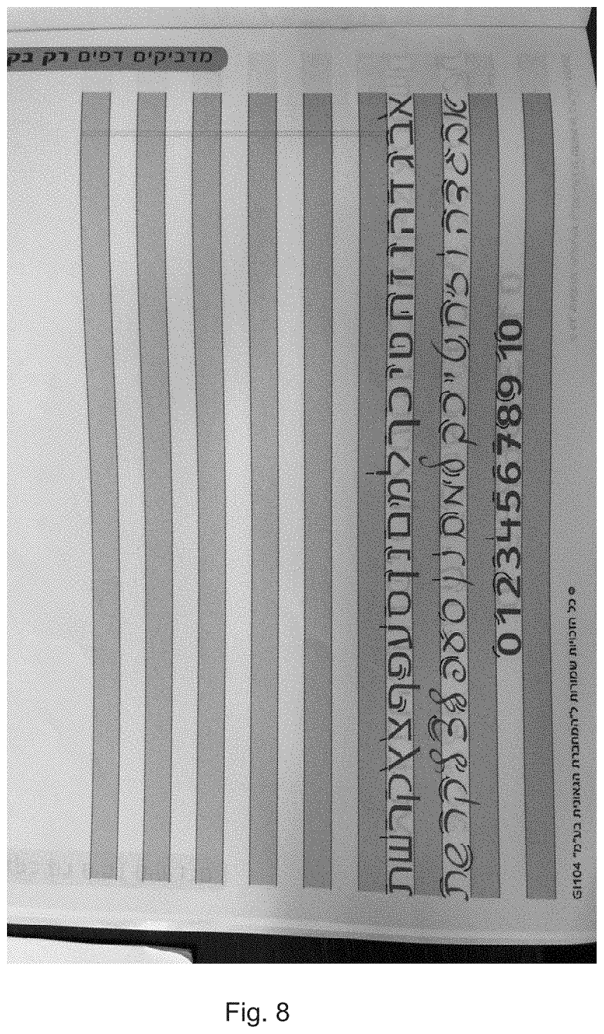

In one embodiment, as seen in FIG. 8, the first color is beige or a variation of beige and has color coordinates within the following ranges of an RGB system normalized to [0 to 255] bytes: R=[240 to 255], G=[240 to 255], B=[207 to 232]. In some embodiments, as seen in FIG. 8, the second color is one of (i) light blue, (ii) light sky blue and (iii) alice blue. In this embodiment, the lines 23 bordering the writing rows 22 and the spacing rows 24 are in the second color and the lines 23 are a shade of the second color that is darker than a shade of the second color appearing in the parallel spacing rows 24. FIG. 8 is not intended to be a precise depiction of the beige or blue hue therein since the photography that generated FIG. 8 has somewhat darkened these hues.

Perfect beige is defined as [R=245. G=245, B=220] in an RGB system normalized to [0 to 255] bytes. However, in an RGB system normalized to [0 to 255] bytes, the term “beige” as used herein refers not only to perfect beige but also to deviations in any one of these three RGB decimal numbers. If no definition of the deviation is provided for an RGB system then the default deviation is a deviation of two or fewer in any one of these three RGB decimal numbers in an RGB system normalized to [0 to 255] bytes.

In one embodiment, the first color has color coordinates within the following ranges of an RGB decimal system normalized to [0 to 255] bytes: R=[254 to 255], G=[248 to 253]. B=[207 to 232]. This represents a range of variations of beige. In another embodiment, the first color has RGB color coordinates within the following ranges of an RGB system normalized to [0 to 255] bytes: R=[254 to 255], G=[247 to 249]. B=[230 to 232]. This range represents perfect cosmic latte (a variation of beige) and slight deviations therefrom. In another embodiment, the first color has color coordinates within the following ranges of an RGB system normalized to [0 to 255] bytes: R=[254 to 255], G=[252 to 254], B=[207 to 209]. This represents perfect cream color within slight deviations.

In one embodiment, the first color is perfect beige (plus or minus 3 in any of the three color coordinates of the RGB decimal system normalized to 0-255), cosmic latte (plus or minus 3 in any of the three color coordinates of this RGB decimal system) or cream (plus or minus 3 in any of the three color coordinates of this RGB decimal system). In one embodiment, the first color is perfect beige (plus or minus 5 in any of the three color coordinates of the RGB decimal system normalized to 0-255), cosmic latte (plus or minus 5 in any of the three color coordinates of this RGB decimal system) or cream (plus or minus 5 in any of the three color coordinates of this RGB decimal system).

In some embodiments, the second color is a light blue that has color coordinates within the following ranges of an RGB system normalized to [0 to 255] bytes: R=[235 to 245], G=[243 to 253], B=[255] which is approximately alice blue. In some embodiments, the light blue has color coordinates within the following ranges of an RGB system normalized to [0 to 255] bytes: R=[168 to 178]. G=[211 to 221]. B=[220 to 230 which is approximately light blue. In some embodiments, the second color has color coordinates with the following ranges of an RGB system normalized to [0 to 255] bytes: R=[130 to 140]. G=[201 to 211]. B=[245 to 255], which is approximately light sky blue.

In some embodiments, the second color is light blue wherein at least one of the following is true: (A) the light blue has color coordinates within the following ranges of an RGB system normalized to [0 to 255] bytes: R=[235 to 245], G=[243 to 253], B=[255] (B) the light blue has color coordinates within the following ranges of an RGB system normalized to [0 to 255] bytes: R=[168 to 178], G=[211 to 221], B=[225 to 235] and (C) the light blue has color coordinates within the following ranges of an RGB system normalized to [0 to 255] bytes: R=[130 to 140], G=[201 to 211], B=[245 to 255].

In one embodiment, the invention is an instructional writing paper notebook 10 configured to enhance cognitive focus, comprising a plurality of sheets 20, wherein for each sheet 20: a series of parallel writing rows 22 of a first color is separated by parallel spacing rows 24 of a second color; a background 26 of the sheet 20 is of the first color: the first color has color coordinates within the following ranges of an RGB system normalized to [0 to 255] bytes: R=[240 to 255]. G=[220 to 255]. B=[200 to 232], the second color has color coordinates within the following ranges of an RGB system normalized to [0 to 255] bytes: R=[240 to 255], G=[220 to 255], B=[200 to 232]; lines 23 bordering the writing rows 22 and the spacing rows 24 are in the second color and the lines are a shade of the second color that is darker than a shade of the second color appearing in the parallel spacing rows 24; and in some embodiments no bright colors or bright contrasts appear on the sheet 20.

The notebook and pages thereof, which may be separately provided, illustrated in FIGS. 1-6, has the following characteristics in one embodiment:
1. The notebook page allows visual focus on the writing row, and cognitive focus during writing and learning processes.
2. Writing row color is light yellow, and line spacing color is light blue. These 2 colors, by way of example, or alternatively other low contrast colors e.g. writing row may be light green and spacing may be gray, or vice versa, induce a high level of relaxation in the learning disability community which is disturbed by contrast with white color regions e.g. background, due to the high reflectivity of white. According to certain embodiments, the writing and spacing rows can each be any suitable color known to be calming and/or low contrast.
3. Writing rows are not marked with strong lines due to the contrast, which bothers students sensitive to visual stress (or who have learning disabilities). Rather, the sheets contain a writing row and a marked spacing line, the spacing line being blue color. In this way, the viewer is able to clearly distinguish between writing row and spacing line.
4. Notebook page is a few millimeters larger than regular paper size (such as A4 size or 8 and ½ by 11 inch), which allows working papers given to students, to be placed smoothly at the edge of the page and become part of (be incorporated into) the notebook
5. Notebook fastened by staples or pins
6. At the edge of the notebook there's special instruction of how and where to glue the working paper, so that the glued page will be browsed as part of the notebook
7. There are letters and/or numbers bar in each model e.g. each page, which includes writing instruction arrows, all to enable writing skills and design an easy and precise letters.

For example, the staples are sufficient to ensure that the sheets 20 of notebook 10 to which loose papers have been glued, for example by a student, do not end up being pulled out of the notebook 10 even though the cumulative weight of these glued-in papers exceeds the weight of a normal page to which no glue has been applied and to which no additional page has been joined.

For example, in some embodiments the sheets 20 of notebook 10 have a height and width that both slightly exceed the respective height and width of pages to be glued in. A4 paper for example is 21 centimeters by 29.7 centimeters. In one non-limiting example, sheets 12 of notebook 10 are 21.7 cm×30 cm, which makes then 0.7 centimeters wider and 0.3 centimeters longer than the size of A4 paper that may be attached by glue. In general, the sheets 20 are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein in some further embodiments an instructional statement is written on the pages of the notebook to prompt such gluing.

As one example, notebook 10 is configured so that loose pages may be glued in by adhering to the margin close to the notebook's spine, thereby to create a continuum in which the loose pages are readable and in the right sequence, and do not even waste the page they are glued to since that page can also be used for writing. For example, if a child writes in his notebook Monday afternoon and Tuesday afternoon and in the interim, pastes a loose page into the notebook Tuesday morning, the paper product herein allows that page to appear in between the written material entered in the notebook Monday afternoon, and the written material entered in the notebook Tuesday afternoon. In contrast, when loose pages are kept in a separate classeur (ring binder notebook), or when they are folded and then glued into the notebook, there is no continuum; the loose pages are neither readable nor in the right sequence relative to other pages in the notebook. Accordingly, the notebook of the invention in some embodiments creates a didactic sequence. This enhances the student's learning of material over the course of time, for example a school semester.

Gluing working sheets into notebook 10, as described herein, also eases orderly browsing through both the integral pages 20 of notebook 10 and the glued-in pages pasted ex post facto by the child end-user of notebook 10.

Accordingly, in some embodiments, as shown in FIG. 1, FIG. 2A and FIG. 2B, each sheet 20 of notebook 10 (in other cases most sheets 20 or some sheets 20) has model letters 40 and/or model numbers 42 appear on at least some of the pages, the model letters and/or model numbers including arrows 44 instructing how to form the model letters 40 and/or model numbers 42. As can be seen in FIG. 1, FIG. 2A, FIG. 2B, in some embodiments, the arrows 44 include a first shape 44A of arrow positioned at a starting point of a first portion 41A of a model letter 40 and/or model number of the model letters and/or model numbers, the first portion 41A configured to be formed first, and a second shape 44B of arrow positioned at a starting point of a second portion 41B of the model letter and/or model number, the second portion 41B to be formed after the first portion. This is illustrated on the model letter “D” in FIG. 1.

In some embodiments of the invention, the model letters and numbers with arrows (or without arrows) are implemented in languages other than English, including those that are written very differently than English, for example, Hebrew and Arabic.

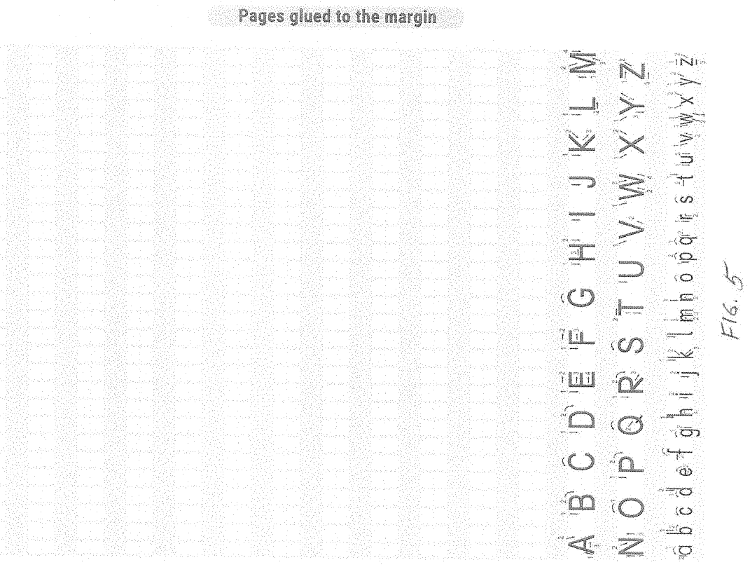

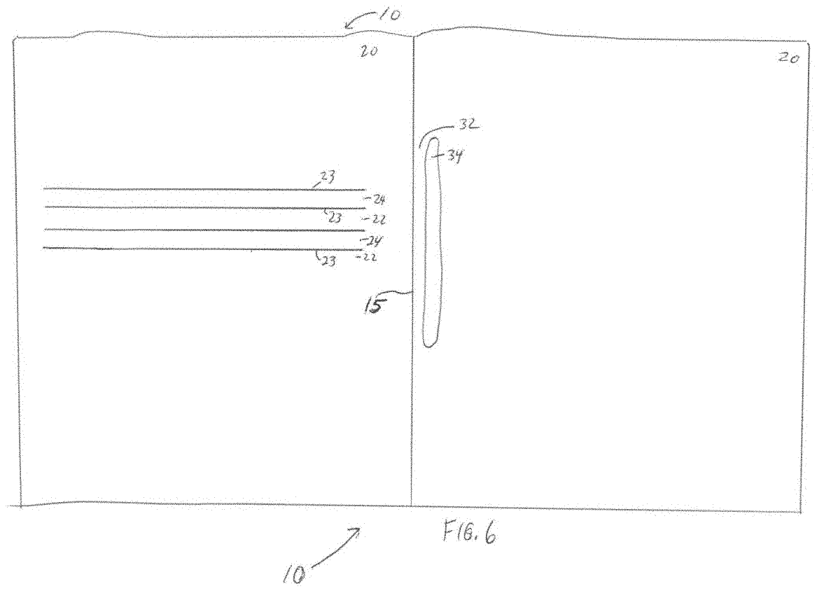

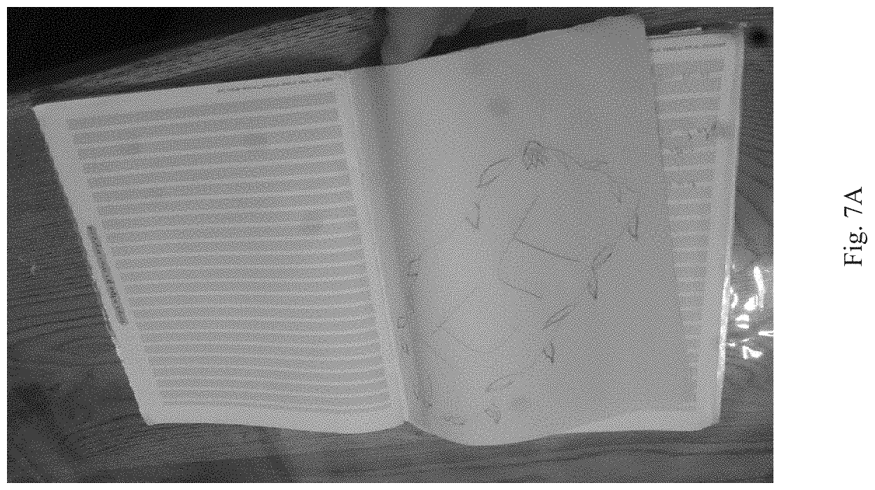

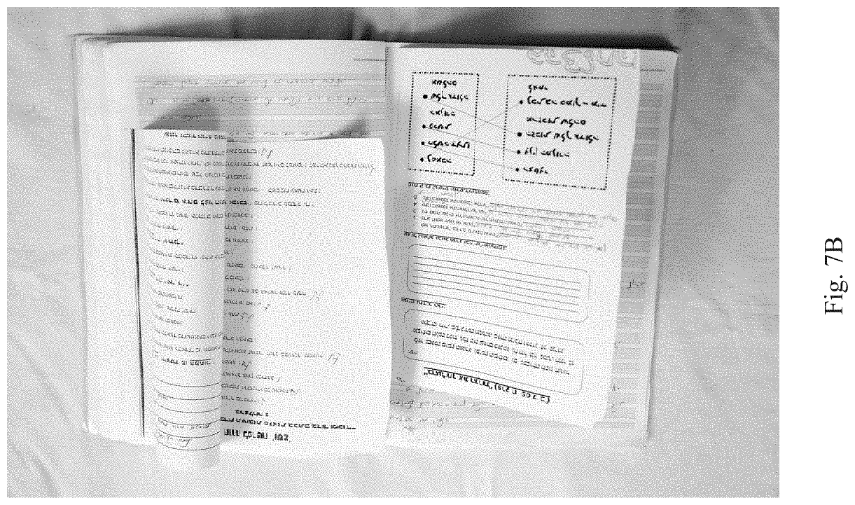

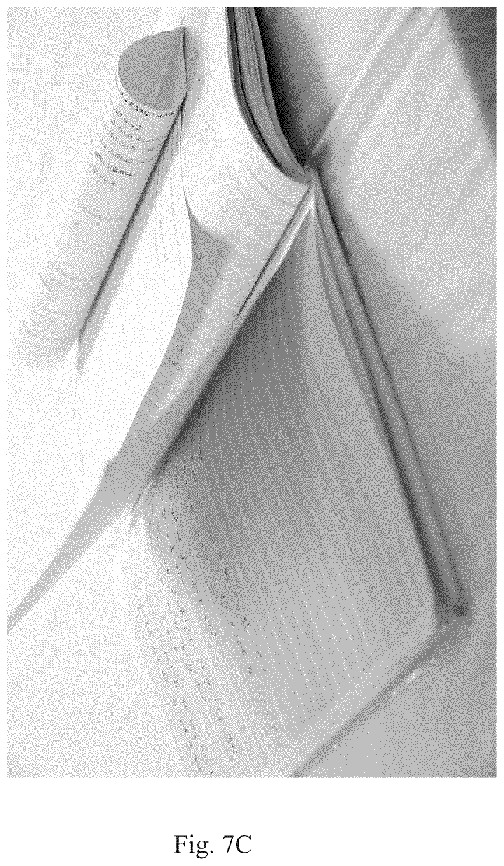

The margin 32 adjacent the spine 15 (FIG. 6) of notebook 10 may include indicia 34 delimiting a region to which glue is to be applied. Interiorly of this region an instruction 34 may be printed reminding the child to apply glue (only) here. FIGS. 7A, 7B. 7C depict three examples of a notebook 10 (with Hebrew writing instructions) with working sheets attached to one or more sheets 20 of notebook 10 at the region having the indicia 34.

Typically no high-contrast lines are present on the page. Typically, the rows intended for writing are a light shade, but are not white; they may be cream, off-white, light yellow etc. The spacing rows 24 are a slightly darker shade e.g. light blue, light gray.

Typically, pages 20 are relatively thick e.g. 90 gram paper rather than more conventional 60 gram paper; the paper may be woodless. This allows both sides of a notebook page to be written on, on the one hand, and prevents traces of the writing on the first side from being visible on the other side, which would have the effect of distracting the learning disabled child. In one embodiment, the pages 20 of the notebook 10 are 80 grams.

A particular advantage of the notebook 10 is use for learning disability students, which are easily distracted from any type of shape or color with high contrast and strong reflex. Learning disability students often suffer from disruption while studying and while writing. In some embodiments, the notebook 10 allows them focused writing, smooth writing and organized learning, which allows them to deal with learning tasks easily, and advance further. One reason is that when the system and method of the invention offloads the visual stress from the page that the student is working on, using the right color and the right level of contrast, the student's brain is not busy with the page, and the page does not intimidate the student. As a result, all of the student's cognitive efforts are available to be focused on the task of the actual writing and not on irrelevant issues. The result is that the writing process is smoother, compared to where the same students work on a regular page.

The cover of the notebook 10 may be laminated or formed of plastic, to protect the notebook in view of the child's difficulty in maintaining her or his notebook in good order.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. An instructional writing paper notebook configured to enhance cognitive focus, comprising:
a plurality of sheets, each sheet having
a series of parallel writing rows of a first color separated by parallel spacing rows of a second color,
wherein a background of the sheet is of the first color,
wherein the first color is obtained by printing at a setting that is from 5% to 10% of the first color using either digital printing software or offset printing software,
wherein the second color is obtained by printing at a setting that is from 10% to 15% of the second color using either digital printing software or offset printing software, wherein the percentage used in the printing setting for the second color is greater than the percentage used in the printing setting for the first color by five or more percentage points,
wherein lines bordering the writing rows and the spacing rows are in the second color, and the lines are obtained by printing at a setting that is from 18% to 22% of the second color using either digital printing software or offset printing software.

2. The notebook of claim 1, wherein the first color is yellow or beige and the second color is cyan or blue.

3. The notebook of claim 1, wherein the first color and the second color are the same color s and are chosen from blue, green, peach, pink and gray.

4. The notebook of claim 1, wherein the first color is beige or cream or cosmic latte and the second color is cyan or blue.

5. The notebook of claim 1, wherein the sheets are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein an instructional statement is written on the pages of the notebook to prompt such gluing.

6. The notebook of claim 1, wherein model letters and/or model numbers appear on at least some of the pages, the model letters and/or model numbers including arrows instructing how to form the model letters and/or model numbers.

7. The notebook of claim 6, wherein the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

8. The notebook of claim 1, wherein no part of the sheets is white and no part of the sheet has a bright color.

9. An instructional writing paper notebook configured to enhance cognitive focus, comprising:
a plurality of sheets, wherein for each sheet:
a series of parallel writing rows of a first color is separated by parallel spacing rows of a second color;
a background of the sheet is of the first color;
the first color is beige or a variation of beige and has color coordinates within the following ranges of an RGB system normalized to [0 to 255] bytes: R=[240 to 255], G=[240 to 255], B=[207 to 232];
the second color is one of light blue, light sky blue, alice blue;
lines bordering the writing rows and the spacing rows are in the second color and the lines are a shade of the second color that is darker than a shade of the second color appearing in the parallel spacing rows.

10. The notebook of claim 9, wherein the sheets are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein an instructional statement is written on the pages of the notebook to prompt such gluing.

11. The notebook of claim 9, wherein model letters and/or model numbers appear on at least some of the pages, the model letters and/or model numbers including arrows instructing how to form the model letters and/or model numbers, wherein the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

12. The notebook of claim 9, wherein the first color has color coordinates within the following ranges of an RGB system normalized to [0 to 255] bytes: R=[254 to 255], G=[248 to 253], B=[207 to 232].

13. The notebook of claim 9, wherein the first color has color coordinates within the following ranges of an RGB system normalized to [0 to 255] bytes: R=[254 to 255], G=[247 to 249], B=[230 to 232].

14. The notebook of claim 9, wherein the first color has color coordinates within the following ranges of an RGB system normalized to [0 to 255] bytes: R=[254 to 255], G=[252 to 254], B=[207 to 209].

15. The notebook of claim 9, the second color is light blue wherein at least one of the following is true:
(A) the light blue has color coordinates within the following ranges of an RGB system normalized to [0 to 255] bytes: R=[235 to 245], G=[243 to 253], B=[255]
(B) the light blue has color coordinates within the following ranges of an RGB system normalized to [0 to 255] bytes: R=[168 to 178], G=[211 to 221], B=[225 to 235] and
(C) the light blue has color coordinates within the following ranges of an RGB system normalized to [0 to 255] bytes: R=[130 to 140], G=[201 to 211], B=[245 to 255].

16. An instructional writing paper notebook configured to enhance cognitive focus, comprising:
a plurality of sheets, wherein for each sheet:
a series of parallel writing rows of a first color is separated by parallel spacing rows of a second color;
a background of the sheet is of the first color;
the first color is beige, a variation of beige or light yellow, the variation of beige being cosmic latte or cream;
the second color is a light blue or a light sky blue or is alice blue;
lines bordering the writing rows and the spacing rows are in the second color and the lines are a shade of the second color that is darker than a shade of the second color appearing in the parallel spacing rows.

17. The notebook of claim 16, wherein the sheets are larger in at least one dimension by a magnitude equal to somewhere between a quarter to three-quarters of a centimeter relative to either A4 size paper or 8 and ½ by 11 inch size paper, to enable attachment by a student of A4 sized pages or 8 and ½ inch sized pages onto the sheets of the notebook by applying glue to a margin adjacent a spine of the notebook, wherein an instructional statement is written on the pages of the notebook to prompt such gluing.

18. The notebook of claim 16, wherein model letters and/or model numbers appear on at least some of the pages, the model letters and/or model numbers including arrows instructing how to form the model letters and/or model numbers.

19. The notebook of claim 19, wherein the arrows include a first shape of arrow positioned at a starting point of a first portion of a model letter and/or model number of the model letters and/or model numbers, the first portion configured to be formed first, and a second shape of arrow positioned at a starting point of a second portion of the model letter and/or model number, the second portion to be formed after the first portion.

20. An instructional writing paper notebook configured to enhance cognitive focus, comprising:
a plurality of sheets, wherein for each sheet:
a series of parallel writing rows of a first color is separated by parallel spacing rows of a second color;
a background of the sheet is of the first color;
the first color has color coordinates within the following ranges of an RGB system normalized to [0 to 255] bytes: R=[240 to 255], G=[220 to 255], B=[200 to 232];
the second color has color coordinates within the following ranges of an RGB system normalized to [0 to 255] bytes: R=[240 to 255], G=[220 to 255], B=[200 to 232];
lines bordering the writing rows and the spacing rows are in the second color and the lines are a shade of the second color that is darker than a shade of the second color appearing in the parallel spacing rows.

21. An instructional writing paper notebook configured to enhance cognitive focus, comprising:
a plurality of sheets, wherein for each sheet:
a series of parallel writing rows of a first pastel color is separated by parallel spacing rows of a second pastel color; a background of the sheet being of the first pastel color;
lines bordering the writing rows and the spacing rows are in the second pastel color and the lines are a first shade of the second pastel color that is darker than a second shade of the second pastel color appearing in the parallel spacing rows;
the sheets have no pure white on them and have no bright colors on them;
at least one of the first pastel color and the second pastel color are each a shade of one of the following pastel colors: yellow, blue, green, peach, pink, beige, gray.
